(19) United States
(12) Patent Application Publication
(10) Pub. No.: US 2010/0005527 A1
(43) Pub. Date: Jan. 7, 2010

(54) SYSTEM AND METHOD FOR PROVIDING AND HANDLING EXECUTABLE WEB CONTENT

(75) Inventor: Yun Ho JEON, Seoul (KR)

Correspondence Address: SCHMEISER OLSEN & WATTS, 18 E UNIVERSITY DRIVE, SUITE # 101, MESA, AZ, 85201, US

(73) Assignee: REALNETWORKS ASIA PACIFIC CO., Seoul (KR)

(21) Appl. No.: 11/813,192

(22) PCT Filed: Jan. 11, 2006
(86) PCT No.: PCT/KR06/00119

§ 371 Date: Jun. 29, 2007

(30) Foreign Application Priority Data
Jan. 12, 2005 (KR) 10-2005-003032

(51) Int. Cl. G06F 9/45; G06F 15/16; G06F 21/20

(52) U.S. Cl. 726/22; 709/203; 717/140; 707/10

(57) ABSTRACT

The present invention relates to a system for providing executable web content to a terminal. The present invention provides a system comprising a server, which provides an executable web content comprising a declarative language part in declarative language and a non-declarative part, and a gateway, which receives the executable web content from the server, converts it into a format executable in a web browser of the terminal, and transmits the converted content to the terminal.

### TECHNICAL FIELD

The present invention relates to method and system for providing various contents and services through a portable terminal, such as a mobile phone, which allows network connection for data communication. More particularly, the present invention relates to a wireless Internet platform that can provide technical characteristics and advantages of both web service and applications downloaded to the terminal.

### BACKGROUND ART

Conventionally, a browser dedicated to wireless Internet, which is represented by Wireless Application Protocol (WAP) browser, was used to access the Internet at a portable terminal. Among several versions of the WAP browser, version 1.x and version 2.x operate quite differently. WAP version 1.x adopts WML (Wireless Markup Language) and WMLScript as the specific content formats. That is, it uses WML, which corresponds to HTML (HyperText Markup Language), the markup language of wired Internet, and WMLScript, which corresponds to JavaScript of wired Internet, to execute simple codes at the terminal. The content represented in such formats is first transferred to a WAP gateway via wired network, and converted to a compact and efficient binary format (referred to as “WBXML”) at the gateway, and then transmitted via wireless network.

However, WAP version 2.x uses extensible HyperText Markup Language (XHTML) Mobile Profile (XHTMLMP) markup language, which is closer to HTML standard of the wired Internet. Also, it is expected that ECMAScript, which is similar to JavaScript, will be introduced in WAP version 2.x.

Regardless of wired or wireless, a browser uses markup language which has limited vocabulary and has declarative grammar, as a content format. Therefore, it is difficult to create content which requires high degree of freedom in terms of representation format. To overcome such restrictions, the following technologies, for example, have been or are to be introduced.

Script: JavaScript is the most representative one. Program codes in a text format (script) loaded on a web server are transmitted to a browser in the text format itself, or in case of WAP, are converted into a bytecode at a gateway and then transmitted to the browser. The Script is a programming language that has relatively more powerful function than that of the markup language. It is used to implement the function that is impossible to implement using HTML, WML, etc. having the declarative grammar formats, at a terminal.

Applet; A Java Applet developed by Sun Microsystems, Inc. is a small program written in Java language. An Applet is complied in advance and loaded on a web server, downloaded by a browser, executed using a Java Virtual Machine in the browser, and then the execution result is displayed on a screen with other content.

Plug-in: ActiveX plug-in of Microsoft Windows, for example, consists of native code that is specific to a terminal platform, and mostly in the form of Dynamic Load Library (DLL). After being downloaded by a browser, it is dynamically loaded and executed. It can use every Application Programming Interface (API) provided by the terminal platform, and can thereby provide various and powerful functions. However, for the reason that the plug-in allows pointer operation and it is difficult to test the function of the program in advance, the plug-in has a drawback that it is hard to prevent viruses or malwares from being executed on a client computer.

The mark-up languages of HTML type were originally made in order to display simple texts and therefore have fundamental limitation. To overcome this limitation of the mark-up languages, the technologies as described above are being introduced as a supplement to the content that mainly uses HTML or WML language. Since each of the above technologies has its own pros and cons, recent PC browsers support all of the technologies above. Therefore, the structure of the browser becomes complex and its size becomes larger. Also, there is a possibility that a security problem may arise in using such technologies and the browser may become unstable. In case of a portable terminal such as a mobile phone, which has smaller computing power and insufficient resource, e.g., a memory, when compared to PCs, a demand for various functions of a browser is growing, and accordingly, the functions similar to those of a browser for PC are being introduced gradually. However, the problems of the size, complexity, and unstableness of a browser pose a bigger problem in case of a mobile phone, compared to a PC.

In the case of a PC, a technology totally different from the conventional HTML was suggested to overcome the limitations and shortcomings of the browser and mark-up languages as described above. In the operating system with the code name “Longhorn,” (which is now known as Vista), a browser that supports a new mark-up format called “Extensible Application Markup Language (XAML)” will be included. ” XAML” may include a portion consisting of “C#” programming language code. It is executed after being converted to Intermediate Language (IL) bytecode, which is executable in Common Language Runtime (CLR) of Microsoft.NET framework. Such conversion may be conducted offline in advance and then the bytecode may be transmitted directly from a server to a browser. Alternatively, the content may be transmitted in a text format to a browser and then converted to a bytecode and executed in the browser. In any case, the content written in the programming language (e.g., C#) and the declarative markup language (XAML) is ultimately converted to Intermediate Language (IL) bytecode, which is directly executable, and is then dynamically loaded and executed by the browser. By utilizing this technology, the advantages of the mark-up language, i.e., a format that can be represented in an easy and compact manner and compatibility with conventional web development methods can be maintained, while taking advantage of merits of universal programming languages (i.e., various user interface and functions) as needed. Therefore, it is expected that far more powerful and convenient user interface may be provided as compared to the websites currently consisting of HTML and additional codes (Script, Plug-in, etc.). However, the technology such as XAML is developed for PCs having powerful CPU and large memory, it is not appropriate to be implemented in a portable terminal such as a mobile phone, which has small computing power and memory.

Meanwhile, in the case of wired Internet, in order to prevent virus infection or disclosure of personal information, security mechanism needs to be placed for content or program downloaded by a user, and therefore, such mechanism is widely implemented. In case of wireless communication, the cost of communication is higher than that of the wired network, and users typically pay for the charge in accordance with the amount of traffic generated. Therefore, if the content downloaded by a user performs some actions without user's knowing it, communication charges unintended by the user may be incurred. That is to say, the user may suffer direct monetary damages, in addition to the conventional problems in the case of wired network such as virus distribution and disclosure of personal information.

The necessity for security function and how it is implemented conventionaly will now be described in detail. When a code directly downloaded from a network, such as, Java Applet, ActiveX, etc., is executed, a security function is required at the terminal device side since it is difficult for the browser to know what action the code is going to perform. If a general binary code is downloaded and executed, that is, in the case of native code (code directly executed by a CPU) such as ActiveX, the terminal cannot check in advance what actions the code will perform, or cannot enforce a specific security policy at runtime. Therefore, such code can be made to undergo the authentication process when being downloaded, in order to prevent virus or malware from running on the terminal.

Meanwhile, in the case of “Java 2 Standard Edition (J2SE),” a representative edition of Java, its specification was made on the premise that the code is initially downloaded via a network, and therefore it provides a security function more elaborated than that of ActiveX. This function takes the form of limiting allowable functions when the code is being executed, mainly depending on what server the code has been downloaded from.

Among the configurations of Java 2 Mobile Edition (J2ME), the Virtual Machine (VM) and runtime library of Connected Limited Device Configuration (CLDC), i.e., the configuration for a device having limited memory and processing power, such as a mobile phone, i.e., have simpler security function, as compared to the J2SE described above, to reduce memory usage and improve execution speed. In MIDP (Mobile Information Device Profile) version 1.x, only simple discrimination is possible, which allows or blocks an access to a sensitive function depending on whether the application is authenticated or not. In the specification of MIDP version 2.0, which was recently defined, the policy on whether to allow the access may be set per each function.

Conventionally, all the security mechanisms of Java for mobile devices assumed that one application is downloaded from one server, and a security policy was selected and applied in accordance with the address of this server. Therefore, there exists a limitation that such policy cannot be changed until the application and the virtual machine are terminated. Thus, if the code constituting the application of one web content can be downloaded from several severs, appropriate security function cannot be implemented using the conventional security mechanism of Java as described above. Further, it cannot provide elaborated security function, which can be applied diversely and sufficiently depending on the circumstances, in other aspects as well.

### DISCLOSURE OF INVENTION

### Technical Problem

It is an object of the present invention to provide a new web platform for providing executable web content, and more particularly, to provide a method and system for providing content with diverse functions and formats via wireless network and executing such content on a portable terminal by overcoming the limitations of low processing speed and memory of a portable terminal.

It is another object of the present invention to provide a method and system for supplementing and making more elaborate the security functions of a wireless content transmitted via wireless network, and a terminal for executing the wireless content.

It is yet another object of the present invention to provide a method and system for improving the efficiency of web content transmission via wireless network.

It is yet another object of the present invention to provide a method and system for implementing cache consistency in caching wireless web content.

### Technical Solution

To accomplish the foregoing objects, in accordance with an embodiment of the present invention, there is provided a system for providing executable web content, wherein the system comprises: a server that provides executable web content comprising a declarative language part in declarative language and a non-declarative part; and a gateway that receives the executable web content from the server, converts it into a format executable in a web browser of a terminal, and transmits the converted content to the terminal.

In the system, the terminal is a wireless communication terminal, and the web content is wireless web content.

The web server and the gateway are connected via wired network, and the gateway is connected to the terminal via wireless network.

The terminal comprises a wireless web browser, and the gateway receives a request for a web content from the wireless web browser via wireless network, and requests the web content to the server via wired network, the web content includes one or more files, the request for the web content to the server includes a request for the one or more files, and the gateway transmits the one or more files included in the web content, which is received from the server in response to the request to the server, to the terminal in one transaction.

The one or more file included in the web content may comprise a web content file and at least one resource file, and the request for the web content may comprise a request for web content file and a request for the at least one resource file.

The web content comprises at least one of a static file, a dynamically generated file, a source code of procedural codes, an executable binary file and a multimedia file.

The non-declarative part may comprise procedural code, and the gateway comprises means for converting the declarative language part to procedural code, and means for compiling the procedural code and converting it into an executable file.

The non-declarative part may comprise procedural code, and the gateway comprises means for compiling the declarative language part, means for compiling the procedural code, and means for merging the result of compiling the declarative language part and the result of compiling the procedural code and thereby generating an executable file.

The gateway may comprise means for detecting whether a function violating a security policy is included in the web content that has been converted into a format executable in the web browser of the terminal.

If a file having a function violating the security policy is included in the web content, the gateway comprises means for preventing transmitting the file to the terminal.

If a file having a function violating the security policy is included in the web content, the gateway comprises means for obtaining approval from a terminal user before transmitting the file to the terminal.

If a file having a function violating the security policy is included in the web content, the gateway comprises means for inserting code into the file, wherein the code causes a predetermined action to be performed at runtime, and the predetermined action is determined by a predetermined security policy of the system.

According to other aspect of the invention, there is provided a system for providing executable web content to a terminal, wherein the system comprises: a server, which provides executable web content, and a gateway, which receives the executable web content from the server, converts it into a format executable in a web browser of the terminal, and transmits the converted content to the terminal, wherein the web content comprises at least one of a static file, a dynamically generated file, a source code of procedural code, an executable binary file and a multimedia file, and the gateway can compile both declarative language and procedural code.

The source code of the procedural code may comprise Java code, and the executable binary file comprises jar file.

According to other aspect of the invention, there is provided a gateway that receives an executable web content from a server and converts it into a format executable in a web browser of a terminal, wherein the web content comprises at least one of a static file, a dynamically generated file, a source code of procedural code, an executable binary file and a multimedia file, and the gateway comprises a complier for compiling declarative language and procedural code and converting into an executable file.

The gateway communicates with the web server via wired network, and the gateway communicates with the terminal via wireless network.

The terminal comprises a wireless web browser, the gateway receives a request for the web content from the wireless web browser via wireless network, and requests the web content to the server via wired network, the web content comprises one more files, the request for the web content to the server comprises a request for at least a part of the one or more files, and the gateway transmits the one or more files included in the web content to the terminal in one transaction.

The one or more files included in the web content comprises a web content file and resource files, and the request for the web content comprises a request for web content file and a request for resource files.

The source code of the procedural code may comprise Java code, and the executable binary file may comprise jar file.

The gateway comprises a converter for converting declarative language part into procedural code; a complier for compiling the procedural code; a handler for analyzing the executable binary file received from the web server and, if an external file is referenced, fetching the external file; and a security manager for determining whether a function causing a security problem is included in the web content received from the web server.

The gateway further comprises means for detecting whether a function violating a security policy is included in the web content that has been converted into a format executable in the web browser of the terminal.

If a file having a function violating the security policy is included in the web content, the gateway does not transmit the file to the terminal.

If a file having a function violating the security policy is included in the web content, the gateway receives approval from a terminal user before transmitting the file to the terminal.

If a file having a function violating the security policy is included in the web content, the gateway inserts code into the file, wherein the code causes certain action to be performed at runtime, and the certain action is determined by a predetermined security policy of the system.

The terminal may comprise a wireless web browser, a web content comprises at least one file, the gateway receives a request for a web content from the wireless web browser via wireless network, the request for the web content comprises a name and a last modified time information of the file that is already cached in the browser, the gateway requests the web content to the server via wired network, the request for the web content to the server comprises a request for the at least one file, and the gateway receives at least one file included in the web content, which is received from the server in response to the request to the server, compares with the name and last modified time information of the cached file, and transmits only the file which has been modified from the cached file or has been newly added to the terminal.

According to another aspect off the invention, there is provided a computer storage media for storing a web browser for browsing an executable web content, wherein the web browser receives and executes web content in binary executable code format.

According to another aspect off the invention, there is provided a terminal comprising a web browser for browsing an executable web content, wherein the web browser receives and executes web content in binary executable code format.

The web content comprises at least one file, and the at least one file comprises a shared resource file which is referenced by web content, and the terminal comprises a cache, and

when the shared resource file is cached in the cache, a reference count representing how many files reference the shared resource file are saved together.

If the terminal receives web content comprising a file of a version newer than a cached version of the cached shared resource file, the shared resource file of the newer version is saved in the cache, and the reference count of the existing cached shared resource file is decreased by 1.

If the reference count after the decrease is 0, the existing cached shared resource file is deleted.

### BRIEF DESCRIPTION OF THE DRAWINGS

FIG. 1 is a schematic diagram of a network system for providing executable web content (“XC”) in accordance with the present invention;

FIG. 2 is a detailed block diagram of FIG. 1;

FIG. 3 is an another schematic diagram of a network system for providing executable web content (XC) in accordance with the present invention, which is for illustrating the security function in accordance with the present invention;

FIG. 4 shows an example of the structure of a Java class file;

FIGS. 5 and 6 are schematic diagrams of a network system illustrating a basic method of reducing the number of transactions in accordance with an embodiment of the present invention;

FIG. 7 is a diagram illustrating an algorithm for a browser, for preventing unnecessary transmission using a cache in accordance with an embodiment of the present invention;

FIG. 8 is a diagram illustrating an algorithm executed at a gateway, for preventing unnecessary transmission using a cache in accordance with an embodiment of the present invention;

FIG. 9 is a diagram showing a method for managing shared resource in a conventional browser; and

FIG. 10 is a diagram showing a method of managing shared resource in accordance with an embodiment of the present invention.

### BEST MODE FOR CARRYING OUT THE INVENTION

The present invention suggests a new type of mark-up language, that is, eXecutable Content Markup Language (XCML), and provides a method and system for providing web content using XCML. Like XHTML or WML, which is a standard format of conventional wireless Internet content, the XCML suggested by the present invention is a mark-up language based on XML. That is, like HTML or WML, XCML is a mark-up language format that mainly consists of declarative language part (hereinafter referred to as a “tag part”, meaning that it is represented using tags). However, just as JavaScript is included in HTML, XCML allows the content that cannot be represented with declarative grammar (non-declarative part) to be represented by procedural code such as JavaScript and to be included in a web content file as a text format (“Java code part”), or allows an external Java file be referenced by in the web content file.

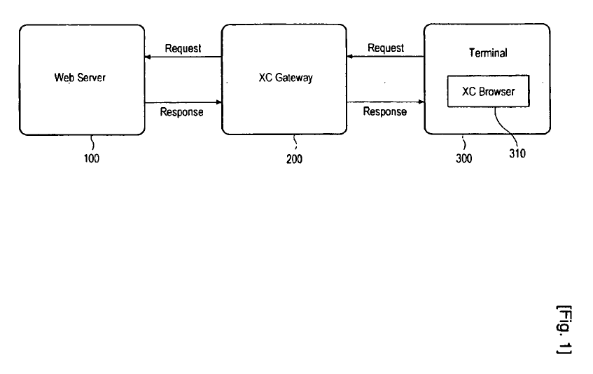

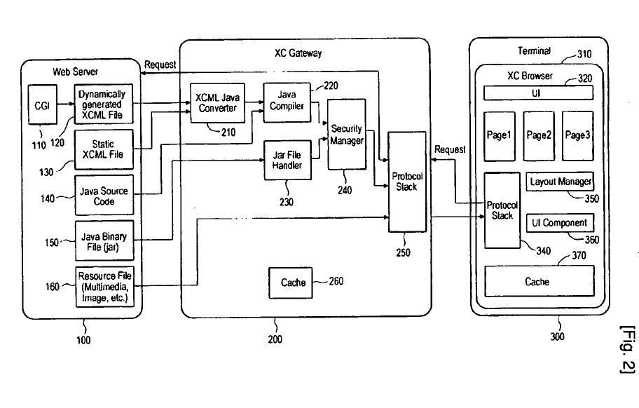

As shown in FIG. 1, a network system for providing content of the XCML format and other web content, in accordance with the present invention, is configured to convert the content into executable code such as Java (generally referred to as “Java bytecode” in the case of Java) at gateway 200 that is connected to web server 100 via wired network, and then transmit the executable code to terminal 300 via wireless network and execute it. Therefore, while the conventional network system consists of a web server (at the server side) and a browser (at the client side), the network system in accordance with the present invention consists of a web server, a gateway, and a browser (client). FIG. 1 is a block diagram showing the network system configured as such, and FIG. 2 is a block diagram showing each element illustrated in FIG. 1, the web server 100, gateway 200 and terminal 300 in more detail, respectively. Hereinafter, each of the elements in FIGS. 1 and 2 will be described. Although it is assumed herein that Java is used as the programming language, and Java bytecode is used As the execution code, the present invention is not limited to the above and other languages with similar characteristics may be adopted.

In FIGS. 1 and 2, web server 100 may be a general web server that provides WAP content or general web content by HTTP protocol. The content provided by the web server may be a static text, an image file, or a file dynamically generated by Common Gateway Interface (CGI), Servlet, etc. This file may comprise text files in XCML (eXecutable Content Markup Language) format (such as files 120 and 130 in FIG. 2) in accordance with the present invention, Java source code file 140, jar file 150 (a file wherein at least one Java class file and other resource files are compressed into one file), or image, music or movie file 160, and so on. Since the XCML file provided by web server 100 may freely include various executable components, it is possible to provide the content that can perform more powerful functions, as compared to the conventional wireless Internet content. Herein, a file refers to not only a file used in the conventional computer file system, but also a collection of data (program code, binary file, etc.) transmitted as one unit via network. According to the present invention, it is possible to develop and provide the content utilizing various functions that are provided by the platform (operating system) itself of the wireless terminal, and such functions are not limited to the functions provided by the browser of the terminal. For example, it is possible to provide content that performs certain action using telephone number information stored in a terminal, which was not possible in a conventional browser.

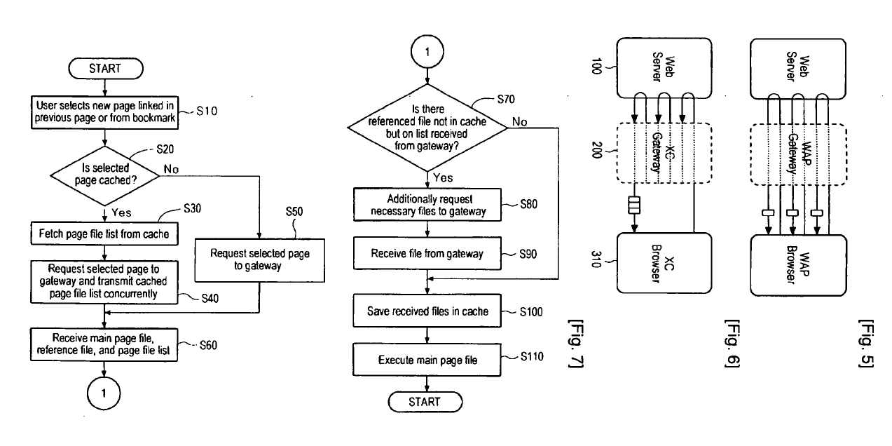

The gateway of the present invention may check with the web server whether it is necessary to update the contents saved in the cache of the terminal in a number of transactions (more than the number of wireless transactions between the terminal and the gateway (“wireless section”)). This is for reducing the number of unit communications (transactions) in the wireless section, since the wireless section has long round trip time and therefore the time delay becomes considerably larger when information is divided and transmitted several times, while a number of transactions in the wired section do not consume much time. According to the scheme of the present invention, the number of traffics between the gateway and the terminal (i.e. the wireless section) are reduced to improve the efficiency, while taking full advantage of the cache function of the terminal. The improvement of communication efficiency using a cache will be described in detail with reference to FIGS. 5-8.

Referring to FIG. 2, the functions of each block in XC gateway 200 will now be described in detail. XCML Java converter 210 performs a function of converting a text file in XCML format in accordance with the present function into Java code according to a predetermined method. The Java code generated here time may be either Java source code in text format or the code of a certain representation format comprising fragments of the source code. As described above, XCML has a part comprising the tags specific to XCML (“tag part” as described above), and a Java code part in the text format. The declarative part consisting of XCML tags is converted to Java code at gateway 200, and merged with a part initially written in Java (Java code part) at server 100, and then compiled to form Java class. There may be several methods to merge the tag part and Java code part and compile the merged code to Java class. One of the possible methods is to convert the tag part into Java source code text, and then merge with exiting Java code part to form one complete Java program source, and then compile it. In this method, XCML Java converter 210 serves to convert the tag part of XCML text file into Java source code in text format, merge it with existing Java code part and transfer the merged result to Java complier 220. Java complier 220 serves to compile the Java source code to form a Java class file.

According to another embodiment of the present invention, the tag part is converted directly to Java bytecode instead of Java source code format, and the Java code part originally written in Java code is complied separately and then merged with the bytecode of the tag part, thereby generating one Java class. In this case, XCML Java converter 210 converts the tag part of XCML file into bytecode, and Java complier 220 compiles the Java code part and merges it with the bytecode of the tag part to generate a Java class file.

If a Java code 140 (in FIG. 2) is referenced by an XCML file, the gateway requests the referenced Java code 140 to the web server and receives it. In this case, the Java code generated at XCML Java converter 210 and the Java code fetched from the web server are merged to generate an executable file. In this case, Java complier 220 serves to compile not only the Java code generated at XCML Java converter 210, but also the Java code fetched from the web server, and then merge them together.

In addition to Java code 140 (in FIG. 2), ajar file 150 may be directly referenced by an XCML file. In this case, the gateway interprets the XCML file, requests the necessary jar file to the web server and receives it. Also, the new web content the browser requests to the web server through the gateway may not consist of XCML file but instead consist of jar file that was initially written in Java and compiled separately. Jar file handler 230 is a block that processes a downloaded file in place of Java complier 220 if the file downloaded from the web server 100 is ajar file which does not need to be compiled. If there are external files referenced by the jar file, Jar file handler 230 extracts the list and fetches them from web server 100.

Likewise, if there are separate files in web server 100 that are referenced by the XCML file, such resources are fetched from web server 100. A separate resource fetcher (not shown) for fetching external resource files that are referenced in the web content file may be implemented in XC gateway 200.

Cache 260 is a space for storing, for examples, the files fetched from web server 100 or the binary files of the complied result. It is known to a person skilled in the art that cache can be designed to perform various functions, and therefore, its detailed functions and relationship with components are not shown herein. Cache 260 is similar to conventional web cache in that the validity of the cache is checked by HTTP protocol standard, but Cache 260 has additional function of storing compiled result as well as the files received from the web server.

Security manager 240 examines whether the bytecode includes codes that cause security problem before the bytecode is transmitted to the client side, i.e. terminal 300. If the bytecode to be transmitted includes the codes that cause security problem, downloading the code may be rejected, or it may be downloaded under the approval of the terminal user. Specific security management method will be discussed in detail hereinafter.

Protocol stack 250 is a set of program components that implement each layer of communication protocol. Protocol stack 250 utilizes HTIP protocol that is modified to minimize round-trip, considering the characteristics of wireless Internet network for connecting to a terminal. Further details of such protocol in accordance with the present invention will be described in detail hereinafter.

The components of terminal 300 will now be described in detail. Terminal 300 may be various types of devices, such as, a mobile phone, a Personal Digital Assistance (PDA), etc., for downloading, executing and displaying wireless Internet content.

The eXecutable Content Browser (XCB) 310 in FIGS. 1 and 2 is a client application that connects to XC gateway 200 and downloads and executes the content mainly consisting of bytecode. XCB 310 is executed on terminal 300.

User Interface 320 means the user interface of the browser 310 itself, such as, common menu. That is, it means the common user interface components that the browser essentially has regardless of the content it is browsing. For example, it comprises Return to previous page, Refresh, Open a URL, Bookmark, History, Option, etc.

In FIG. 2, Page 1, Page 2, and so on are the blocks each representing the unit of content that is downloaded form the server and executed. Each page is specifically defined by Uniform Resource Indicator (URL) and may consist of one or more Java class and resource file.

User Interface component 360 means a component of UI, such as, label (one-line text box), button, etc., which can be used or inherited in XCML or Java program. Specifically, according to an embodiment of the present invention, in XCML, each UI component can be represented using one tag corresponding to the component. For example, to generate a button where a text “Help” is displayed thereon, it can be described as:

<button text=“Help”/>

This tag is converted to the code that generates one instance of a specific class, for example, class “widerthan.xcb.Xbutton” that is a UI component. According to the present invention, it becomes possible to extend or modify in the content the look & feel or function of basic UI component 360 that the system (XCB) provides. That is, in order to extend or modify the basic UI component, a new class may inherit the Java class corresponding to the UI component and be supplemented with some functions or be modified. For example, a class named MyButton that inherits the class widerthan.xcb.XButton is defined in the “header” part of the XCML content, and to utilize this class, a tag is defined in the “body” part of the XCML content as follows:

<button text=“Help” class=“MyButton”/>

Layout manager 350 (often referred to as layout engine) serves to arrange UI components 360 on a display screen as defined in the content. For example, if the content of the web server defines that a button component having a predetermined shape is arranged at the left side of the screen, layout manager 350 serves to arrange the component to match the original content when the bytecode converted from this content at gateway 200 is being executed in XC browser 310.

Cache 270 serves to cache Java bytecode and other resource files downloaded from the server. As will be described in further detail below, the communication traffic in the wireless section between gateway 200 and terminal 300 can be reduced through appropriate caching.

The protocol stack of browser 3 10 corresponds to the protocol stack of XC gateway 200.

As described above, like HTML or WML, XCML mainly consists of the part having declarative language format, and, just as JavaScript is included in HTML, the content that cannot be represented with declarative grammar may be represented by Java code and included in a web content file, or an external Java file may be referenced in the web content file (XCML file).

In the conventional network system comprising a web server and a terminal, a web content file including declarative mark-up language and JavaScript parts can be displayed on the terminal screen by the following exemplary processes.

(1) The browser of the terminal requests a web content file designated by a specific URL to the web server.

(2) The web server generates a web content file or reads the web content file designated by the URL, and transmits either of these files through the network.

(3) The browser of the terminal downloads and parses said file.

(4) A parser generates UI components according to a predetermined method and initializes them with a format designated in the file.

(5) JavaScript part is converted into executable internal representation format and then saved.

(6) User input may be handled according to the property designated when each UI component was initialized. In case a function that is not the basic function of the UI component is performed, a user input is handled by calling a JavaScript linked to the UI component. For example, initializing a color of a specific UI component to be changed when a user input such as a button input gives focus to the specific UI component among several UIs, can be implemented with the following code:

<a href=“http://www.foo.com”
onfocus=“JavaScript:this.style.backgroundcolor=‘yellow’”>
Link
</a>

According to such initialization configuration, the user input that moves focus to a specific component is designated to cause action “change color”.

Compared to the above, in order to download and execute the XCML file in accordance with the present invention at the terminal, following processes, for example, are performed.

(1) The browser (terminal) connects to predetermined XC gateway 200 and transmit s the request for the XCML file designated by a certain URL.

(2) The gateway requests XCML file requested from terminal 300 to the server 100.

(3) XCML file is generated or the file designated by the URL is retrieved in server 100 and sent to the network.

(4) Gateway 200 downloads and parses XCML file and obtains Java executable code. Code obtained here can perform the action (of generating UI component and initializing it) that is same as that of the above conventional browser.

(5) The gateway compiles the java code included in the downloaded XCML file or the external Java code referenced by the XCML together into Java executable code and sends it to XC browser of terminal 300.

(6) XC browser 310 downloads the Java bytecode and dynamically loads the class corresponding to the Java byte code and executes this code. That is, XC browser 310 downloads Java bytecode from the network and loads it to Java virtual machine which is being executed, thereby enabling use of class defined by the bytecode in application and then executes the codes. In this process of executing the codes, UI components are generated and initialized.

(7) Input of the user is processed by the UI components generated in the above process of (6) or is processed by Java codes separately included.

The major difference between browsing method using conventional web server and browser of the terminal and the method of the present invention is as below.

(i) While conventional browser includes within the browser functions that analyze web content file and generate and initialize UI component 360, gateway 200 has such functions according to the present invention. In other words, gateway forms Java code and downloads it to the terminal, and the client merely executes the downloaded code.

(ii) In the conventional browser, procedural component is represented in JavaScript, and the part represented in JavaScript can be executed by using JavaScript compiler and bytecode interpreter, which converts the part represented in Javascript to executable format (generally, unique bytecode). On the other hand, according to the present invention, procedural code expressed in Java is compiled together with declarative language portion to be converted into Java bytecode, and then, executed in Java Virtual Machine (JVM) in the terminal.

Advantages of the present invention includes the followings.

Since code formed by declarative grammar (of declarative language part) and procedural code (of non-declarative part) uses the same Application Program Interface (API), the two can work together more directly and efficiently.

All APIs and functions that Java Virtual Machine (JVM) and a terminal library have can be utilized without being limited by the browser of the terminal. The terminal can immediately execute codes without parsing a web content file.

Even when new grammar is added to markup language that represents the content, modification of the browser in the terminal such as adding corresponding function is not necessary.

Security Function

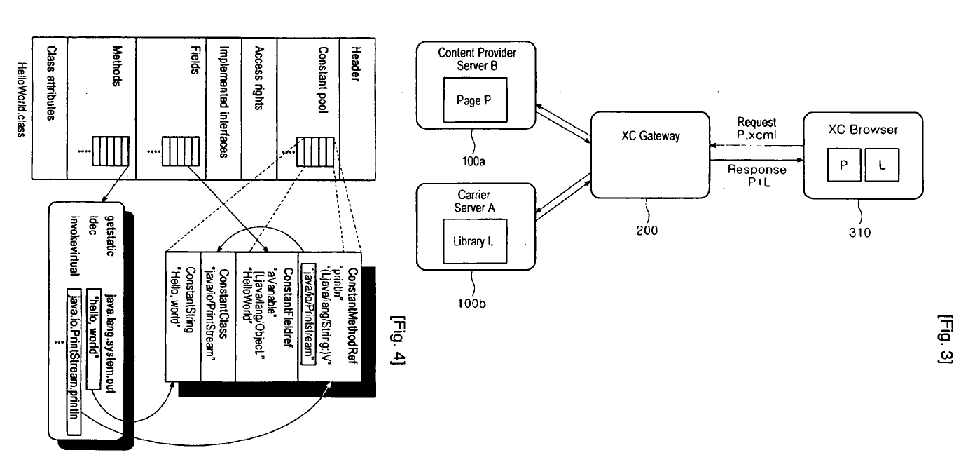

The security function according to the present invention will be described with reference to FIG. 3.

FIG. 3 is a schematic diagram of network system for providing executable web content (XC) according to the present invention. With reference to FIG. 3, security function according to the present invention will be illustrated. To execute page P of server B of Content Provider (CP) in a terminal as shown in FIG. 3, if P references library L existing at server A of a common carrier, XC Gateway 200 downloads Java application in which P and L is combined to client (XC Browser 310). At this time, different levels of security policies may be applied to library of the carrier and program of the content provider. In other words, a security policy may need to allow L, which is managed by the carrier to use all functions of the terminal, and to block P from accessing some specific functions such as dialing, phone directory and so on.

According to the present invention, new security mechanism is provided by which one can apply different security policies within one content (P+L). In the present invention, unlike the conventional method, a gateway may statically examine Java code downloaded from each server, and in the case codes that violates security policy designated for each server are found, downloading of such code may be prohibited or download can be done subject to the approval of the user.

Security policy according to the present invention will be explained in detail below. In case the web page is written in markup language instead of Java code, the specific method of enforcing security policy when gateway 200 parses the file and create Java code is known. Accordingly, further explanation on such case is omitted. Instead, the structure of Java class file and the corresponding security mechanism will be explained hereinafter.

In case gateway 200 downloaded Java source code or binary file (class file or jar file that includes class file) from any server 100, the gateway should be able to decide and control which function of the terminal is accessed by the code in order to implement security function. To do this, the gateway needs to analyze Java class file. FIG. 4 shows one example of the structure of Java class file. Among these, the bytecode that is actually being executed is included in methods section. While native code (for example assembly code) can access any memory, Java bytecode, which is executed through Java interpreter or JIT (Just-In-Time) compiler, can only access class and function assigned by constant pool (refer to FIG. 4) in class file

When gateway 200 discovers that certain code is accessing class or function (for example, reading of phone directory) to which access is prohibited under the security policy, it must take a proper measure such as prohibiting the use of the code or enabling the use of the code only after getting the approval by the terminal user. There may be several methods for implementing such measure. Described below are some examples of such methods. Among these methods, a specific method to be applied may be determined by the policy of the carrier or security policy assigned for each different security domain.

(a) Method of prohibiting download: If class files composing the page that user (i.e. client) wants to download include codes that violate security policy, download of these files from the gateway to the terminal is terminated and it is informed to the user and the manager. In embodiment shown in FIGS. 1 and 2, above function is performed by security manager 240.

(b) Method of confirming with the user when downloading: The user is notified of the function that the page (that the user requests) accesses, and, after the user approval, the browser moves to the page. For example, if a page requested to the gateway by a client references dial function, the gateway informs the user of the fact (for example, the gateway sends o the terminal the message “This program includes dial function. Do you wish to proceed?”), and the gateway is notified of whether the user approved or not. If the user approves, the page is downloaded to terminal.

(c) Method of receiving approval of the user at runtime: The two methods above have a feature of prohibiting download completely before certain code actually violates security policy. However, there may be cases where it is desirable to prohibit or requires user approval when such security violating code is executed. In other words, rather than entirely blocking the code of certain function, security policy may be applied differently according to what it actually does during execution. For example, instead of blocking access to all servers, access to certain servers may be allowed. Also, instead of entirely blocking a code that accesses file of a terminal, access of certain file (file in certain directory) may be allowed. Selectively applying security policy according to different conditions during runtime cannot be done in the gateway but should be done in the terminal during runtime. Therefore, a code that performs certain action during runtime may be inserted in a program in the gateway in order to implement the desired function. Embodiments of the method of checking during runtime in a program are explained below. First method is to replace referenced class: when a code of certain wireless web page P accesses function F of class C to which access is prohibited due to security policy, a new class C1 that inherits class C and overrides function F may be prepared in advance in the terminal or downloaded as part of P. In the terminal, function F of class C1 calls function F of class C only when the user approves it. To implement such security function, the gate modifies the entry that references C in constant pool of the class included in P into an entry that references C1 and the modified version is downloaded to the client. Since C1 inherits C, for all functions except F function of C is called as it is, and functions of original page P is all performed except the execution of F. The method above has a drawback that it cannot be applied if override is impossible, which can be a case if class C or function F is final.

Second method is provided to overcome such drawback: a new class D is made instead of C1 that inherits C, and after F of D is approved by the user F of C is called. Since D is not a class that inherits C, but simply functions to call F, if reference for C of constant pool is replaced by D as described above, it cannot call function other than F. Therefore, new entry for D is made in constant pool and bytecode in method section is scanned to change the code that calls problematic F of class C into the code calling F of class D instead, while code that requires to receive approval of the user before F of C is called is inserted in F of D.

According to the method above, different security policies can be set and enforced only to a part of the code. That is to say, for example, if a page is being downloaded from different servers, different security policies can be set and enforced to such codes.

Other than described above, there may be various ways to apply security policy according to the condition during runtime.

Communication Efficiency Improvement

Compared to wired internet, response speed is generally slow when a browser of conventional method (WAP, especially web) is used in wireless internet due to slow transmission speed of wireless internet and especially due to Round Trip Time (RTT) that is slower than the transmission speed. In the case of conventional browser, other files needed by the page, such as image files, JavaScript files, cascade style sheet (CSS) files and etc. can be requested to server after downloading the text written in HTML or WML from server and parsing it. Therefore, to show one page, several times of transactions (request and response) should be performed. In the case of wired (PC) browser, methods of using pipeline protocol of HTTP 1.1 or of opening with the server two or more TCP connections are used in order to shorten the time to download many files. In the case of WAP browser used in wireless internet, pipeline of HTTP 1.1 or multiple TCP connections are mostly not used due to implementation problem. Also, even if implementation is possible, opening multiple TCP connections brings delay needed for initialization of each connection and overhead due to slow initial speed which is a feature of TCP, and therefore it is not efficient in wireless Internet where such effect of delay or overhead is especially critical. Also, although pipelining of HTTP 1.1 has the effect of shortening overall page-loading time, in the case of webpage referencing external files, sum of time need for at least two transactions (i.e. a transaction to receive page text, and a transaction to request remaining resource/files that are decided after text parsing) and time spent in parsing received files is needed.

Using the improved protocol according to an embodiment of the present invention, one can minimize the number of transactions while preventing increase of transmission amount, thereby shortening page-loading time.

FIGS. 5 and 6 are diagrams for illustrating the method of reducing the number of transactions according to an embodiment of the present invention. FIG. 5 shows the process of a single webpage containing a number of files being downloaded to the browser in conventional wireless internet server and browser. FIG. 6 shows the process of downloading a single webpage containing a number of files to the browser according to an embodiment of the present invention. In FIG. 5, one arrow means one transaction, and a small rectangle represents one file. According to the method shown in FIG. 5, the browser first brings text file and after analyzing it, the browser subsequently fetches files that are referenced within the page. Therefore, one transaction occurs per one file, and all transactions are done through wireless network. Even if the overall system includes a gateway between the server and the browser (when the gateway shown in dotted line in FIG. 5 exists within the system), the conventional gateway merely passes file requests and the responses as they are, and the browser entirely determines which files are to be transmitted from the server. Therefore the gateway in the conventional system did not affect the number of wireless transaction.

Meanwhile, according to an embodiment of the present invention shown in FIG. 6, if browser 310 requests some webpage to gateway 200, gateway 200 can fetch other files that the page requires from server without the involvement of the browser and transmits all the files together to the browser. To do this, gateway 200 should be able to determine files which a specific page needs. It means that the gateway finds out what other files are required by a page when the browser requests the page by specifying one URL (representative URL) that represents the page. XC Gateway 200 according to the present invention fetches XCML file corresponding to representative URL transmitted from browser 310 from the server and parses the fetched file, and thus, it can know external files referenced statically in XCML file. And accordingly, it can request these files to web server 100 without request from the browser, collect them with a file of page text, and download them together to browser 310 of a terminal. By doing so, the gateway thereby transmits data, collected from server through several times of transactions in wired section, to the terminal through one transaction in the wireless section. In the example shown in FIG. 5 and FIG. 6, it is assumed that 3 files are included in one webpage. Comparing the number of transactions, 3 times of wireless transactions are included in the case of FIG. 5 (without the gateway), while 1 time of wireless transaction and 3 times of wired transactions are included in FIG. 6. Since RTT in wired network interval is generally much shorter than that of wireless RTT, several transactions in wired transaction have little effect on total response time. Therefore, the method of FIG. 6, which has smaller number of wireless transactions, has higher communication efficiency than that of FIG. 5.

Also, according to another embodiment of the present invention, to make communication method more efficient, if a new version of the page being browsed is cached in cache in a terminal, the page is not downloaded again to minimize the time spent in communication.

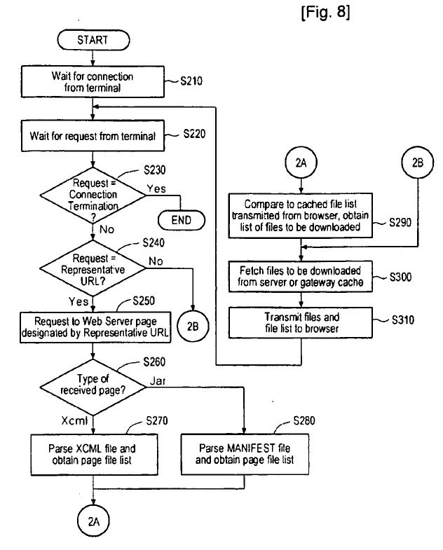

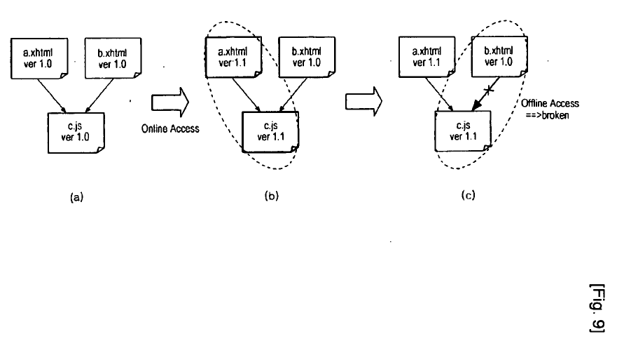

In the case of wireless internet, in many cases, the user pays fee per packet in proportion to transmission amount, and thus, unnecessary download can result in excessive amount of fee and slowing of response time. Accordingly, it is desirable not to download again if certain file is already cached in a browser. FIGS. 7 and 8, according to the present invention, are to illustrate the algorism that prevents unnecessary transmission using cache, and respectively shows algorism executed in the browser side and the gateway side. In the following, cache use algorism of the present invention will be explained before explaining the operations of the browser and the gateway in reference to FIGS. 7 and 8.

1. When browser 100 request a page to gateway 200 by using a URL which represent the page, and if the page is cached in a terminal, it notifies the gateway of the last modified time of cached web content file, and “cached page file list” that contains names and last modified time of each file that remains in the cache among the files referenced by the page. To do this, a browser saves associated files of each page (main page and referenced files) and cached page file list together in cache. According to an embodiment of the present invention, files saved in cache is expired in page unit and are deleted from cache, and so in most cases, files referenced in the main page remains in the cache together with the main page. In case the main page is updated to reference new files, files saved in cache and the actually referenced files become different.

A gateway requests the web content file corresponding to representative URL required by the browser.

2a. In case a gateway received from the server a main page of XCML type: XCML is parsed. As a result of the parsing, a page file list, which is a list of files that the page references, is obtained. The page file list, as explained before, contains file names that are required by certain page and the last modified time of the files. The new version of the files included in the list is fetched from the server and is saved in a cache of the gateway. Then, if the contents of the gateway cache are new, the actual contents are not downloaded based on HTIP If-Modified-Since protocol. At the same time, data of the last modified time is added to the page file list. The gateway compares page file list of which a browser sent in step 1 and is cached in the browser and page file list obtained as the result of parsing in the gateway. As the result of comparison, the gateway sends to the browser in a terminal the files changed from or newly added to the cached files together with the page file list obtained in the gateway. The gateway also instructs the browser to delete files that do not exist at the server side. If the filename and last modified time of the files cached in the browser and those of the files in server are same, it is decided that the files have not been changed and thus are not downloaded.

2b. If a web content file received from the server is a binary file: Such binary file is constructed to have both Java class file and meta data of the corresponding page. For example, if it is a jar file which is normally used in packaging and transmission of Java program, it contains a text file called MANIFEST.MF in an interior directory called META-INF and the file contains information such as version, name of program, start class, and so on. According to an embodiment of the present invention, MANIFEST.MF file further includes a list of other files referenced in the corresponding file in addition to the information conventionally included in the MANIFEST.MF file. In this case, the gateway parses such meta data file (MANIFEST.MF) and obtains a page file list that includes referenced filenames required by the main page and last modified times of such referenced files. Then, files which need to be newly downloaded (i.e. files different from the ones cached in a browser) are downloaded by the browser in the same procedure as in the case of XCML type main page explained above.

In case the browser transmits representative page URL only and does not transmit a page file list in step 1, in other words, in case the browser is not caching the corresponding page, the gateway first transmits a page file list to the browser without transmitting actual files in step 2a and 2b. This is to prevent unnecessary download in case a part of the files is referenced by a different page and already exist in the cash even though the browser does not cache the requested page itself.

3. Through the above process, a browser receives files and a page file list that the gateway sends (S60). If a file included in the list is not received, and is not saved in cache or the last modified time of the file saved in cache is earlier than the last modified time displayed in the list, such a file is requested to the gateway.

4. A browser saves in the cache the files that did not exist previously in cache, and updates the cache in case it receives updated files. The page file list including a list of files referenced by the page and so on is also updated based on the received information (S100).

5. When downloading and storing of files is finished, Java class corresponding to the page is loaded and executed. (S110)

According to the above method, all necessary files can be downloaded through as many as two transactions between the browser and the gateway without unnecessary transmissions.

In the following, steps performed in a terminal in order to implement the method as described above will be explained with reference to FIG. 7.

In step S10, if a user requests a new page, for example, by clicking any link in a page previously viewed or selecting a page from a bookmark, it is determined whether the contents of selected page is cached in the terminal in step S20. If the selected page is not cached, the page is requested to the gateway in step S50. If the selected page is cached, the browser retrieves the cached page file list from the cache (S30). When requesting the page to the gateway, it transmits the cached page file list to the gateway (S40). The browser receives in step S60 a main page file (or web content file), referenced files, and a page file list transmitted from the gateway at the request of the browser. In step S70, the browser checks whether there are files included in the list received from the gateway but are not being cached. If there are files that are not cached, the missing files are additionally requested to gateway (S80) and received (S90), and when the reception is complete and there are no more files to receive, the files received are saved (S100) in the cache, and the main page file (or web content file) is executed (S110).

Next, steps performed in the gateway in order to implement the method as described above according to an embodiment of the present invention will be explained with reference to FIG. 8.

In step S210, the gateway waits for the terminal to connect and initiate communication. When the terminal connects to the gateway, it establishes communication between them based on a predetermined setup process and moves on to step S220. In step S220, it waits until the terminal makes a request and then receives the request. In step S230, it determines whether the received request is a connection termination request, and if it is a connection termination request, it terminates operations related to the connection of corresponding terminal. If it is not a connection termination request, it determines whether the request is a request for representative URL (S240). Request for representative URL means, when the user newly requests certain pages by entering URL or clicking a link, a request of the data of corresponding URL. Request of representative URL is a concept opposed to the request of missing files after receiving a part of files of a desired page at the browser. That is to say, as previously stated, after files needed for execution of single web content file are transmitted to the browser, the browser determines if files needed to complete a page are all received, and requests for missing files if there are any. The request of the browser to the gateway includes not only basic requests such as connection request and connection termination request, but also request for representative URL, request of individual files (when some files for completing a page is missing) and more. In the case of request for representative URL, the gateway receives from the browser a cached page file list that includes names final modified time of the cashed files among the files necessary for the corresponding page.

If a request from the browser is a request for representative URL, the gateway requests the contents of the main page of the corresponding URL to the web server (S250). The gateway checks the type of received page (S260) after receiving the main page file (web content file) and if the received web content file is of XCML type, it parses the file, thereby obtains a page file list (S270). If the received file is a binary file such as jar file, it parses MANIFEST file and obtains a page file list (S280). After obtaining the page file list, the list is compared to the cached page file list received from the browser, and a list of files that need to be newly downloaded to the browser is obtained (S290). After the files to be downloaded are determined, the files are retrieved from the server or cache within the gateway (S300), and are transmitted with the file list to the browser (S310).

In step S240, if the request from the browser is not a request for representative URL, it means that the browser is requesting missing files. In this case, corresponding files are retrieved from the server or cache (S300), and then corresponding files are sent to browser (S310).

Other than the methods explained above, there can be other specific methods of using the cache in the terminal efficiently by informing the gateway of the files cached in the terminal in advance and for the gateway to transmit necessary files only.

Shared Resource Management Function

As in the case of conventional web related system, it is desirable to share libraries and images commonly used by different pages, thereby elevating cache usage rate in an XCB based system for many reasons such as page loading speed, packet payment, cache usage amount, etc. However, sharing resource such as libraries or images (hereinafter referred to as shared resource) among different pages can result in circumstances where versions of such shared resources become inconsistent.

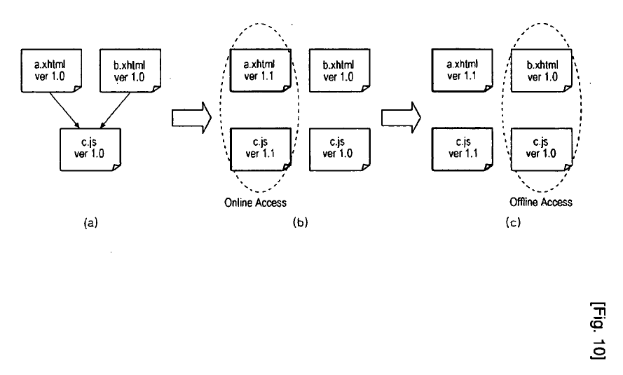

FIG. 9 is a diagram showing the method to manage shared resource in the conventional browser a.xhtml and b.xhtml are XHTML files that represent different pages, and are sharing JavaScript library c.js. FIG. 9(a) shows the situation where version 1.0 of two xhtml files are in the server, and these two files shares x.js version 1.0, and all files are cached in a terminal.

When all files in server are upgraded to version 1.1, FIG. 9(b) illustrates a situation where a terminal has accessed a.xhtml page and a.xhtml and c.js files of the terminal cache are respectively upgraded to version 1.1 while the terminal is connected online with server. If the terminal goes offline at that state, and when the user attempts to use b.xhtml page, version inconsistency occurs since b.xhtml is version 1.0 while c.js is version 1.1 as shown in FIG. 9(c).

Version inconsistency problem, which may occur when different pages share certain resources, is a phenomenon that appears not only for web pages but also when installing several applications in a desktop operating system. The simplest way to solve this problem is not to share resources among webpages and place each individual copy file in different places per each webpage. But this method is difficult to adopt due to the limited memory size of the terminal, especially when there are many small pages.

According to an embodiment of the present invention, a method shown in FIG. 10 is used to solve previously mentioned version inconsistency problem.

FIG. 10(a) and like FIG. 9(a), shows situation where server has version 1.0 a.xcml, b.xcml, c.java files and the same version is cached in the client. In this embodiment, all resource files that can be shared have its own reference count. Reference count represents how many different files reference the file at issue. For example, reference count of c.java in FIG. 10(a) is 2.

In FIG. 10(b), the terminal accesses a.xcml page online and obtains version 1.1 a.xcml and version 1.1 c.java files. Here, as previously explained, files actually transmitted and saved in the terminal are not XCML and source files of Java, but class files that were generated in a gateway from the XCM and Java source files. However, for convenience sake, the files will be referred to by the name of a source file in FIG. 10. At this time, reference count of c.java of version 1.0 previously saved in the cache before saving c.java of version 1.1 in the terminal is decreased by 1. At the same time, as shown in FIG. 10(b), c.java of version 1.0 is not deleted if the reference count of original version after the decrease is not 0, and c.java of version 1.1 is separately saved. Version 1.1 a.xcml replaces version 1.0 a.xcml, and it has a link that can access version 1.1 c.java.

As shown in FIG. 10(c), if the client accesses b.xcml offline, originally linked version 1.0 c.java is used. If a.xcml is accessed, version 1.1 c.java is accessed together.

If a shared resource file whose reference count is 1 is updated, only the updated file remains and original resource file is deleted (since the reference count of the original resource file becomes 0). According to the above explained method, efficiency is increased by storing only one file in the case of sharing the same version of the same resource in multiple pages, and at the same time, version inconsistency can be prevented by saving different versions as needed.

The following is pseudo codes to illustrate an example of the algorism for implementing the operation as described above. Hereinafter, “page” means a web content file that its corresponding “URL” represents and “resources” is a list of resource files required by the “page.”

```
function download_page(url):
page, resources = request_page(url)
for r in resources:
*179 cache_resource(r)
cache_page(page)
function cache_page(page):
  if page.url in cache:
  ; unlink previous page
  for r in cache[page.url].resources:
  r.ref_count--;
  if r.ref_count==0:
  delete cache[r.url+r.version]
  ; put new page
  cachefpage.url] = page
  for r in page.resources:
  cache[r.url+r.version].ref_count++
function cache_resource(r):
  cache[r.url+r.versoin] = r
```

Each block illustrated in the figure herein conceptually shows the function of a program. During the process of implementing the invention into an actual program, one block may be implemented into one or more parts (components) of the program, or the functions of several blocks may be implemented into one program component or implemented into several program components. Method of implementing detailed functional block subject to various modifications and combinations by a person skilled in the art.

### INDUSTRIAL APPLICABILITY

Since the web content which has been converted into a form that is directly executable at terminal 300 is transmitted from gateway 200 to terminal 300, rapid execution and display of the content is possible even in the terminal having limited processing power.

Since the code generated by using declarative grammar and the procedural code use the same Application Program Interface (API) and object, interlocking between the two types of codes is more direct and efficient.

Without being limited by the browser of the terminal, Java Virtual Machine (JVM) and all API and function of the library of the terminal can be utilized. And the code is executed immediately without a process of parsing a web content file in the terminal.

Even when new grammar is added to the markup language that represents content, there is no need for a change of the browser of the terminal.

Communication efficiency can be increased by minimizing the number of communications in the wireless interval and using the cache efficiently to decrease the traffic. Cache efficiency can be maintained while maintaining the consistency of cached file and preventing version inconsistency.

1. A system for providing executable web content, wherein the system comprises:
a server that provides executable web content comprising a declarative language part in declarative language and a non-declarative part; and
a gateway that receives the executable web content from the server, converts it into a format executable in a web browser of a terminal, and transmits the converted content to the terminal.

2. The system of claim 1, wherein the terminal is a wireless communication terminal, and the web content is wireless web content.

3. The system of claim 1, wherein the web server and the gateway are connected via wired network, and the gateway is connected to the terminal via wireless network.

4. The system of claim 3, wherein
the terminal comprises a wireless web browser,
the gateway receives a request for a web content from the wireless web browser via wireless network, and requests the web content to the server via wired network,
the web content includes one or more files,
the request for the web content to the server includes a request for the one or more files, and
the gateway transmits the one or more files included in the web content, which is received from the server in response to the request to the server, to the terminal in one transaction.

5. The system of claim 4, wherein
the one or more file included in the web content comprises a web content file and at least one resource file, and
the request for the web content comprises a request for web content file and a request for the at least one resource file.

6. The system of claim 1, wherein the web content comprises at least one of a static file, a dynamically generated file, a source code of procedural codes, an executable binary file and a multimedia file.

7. The system of claim 1, wherein the non-declarative part comprises procedural code, and
the gateway comprises means for converting the declarative language part to procedural code, and means for compiling the procedural code and converting it into an executable file.

8. The system of claim 1, wherein the non-declarative part comprises procedural code, and the gateway comprises means for compiling the declarative language part, means for compiling the procedural code, and means for merging the result of compiling the declarative language part and the result of compiling the procedural code and thereby generating an executable file.

9. The system of claim 1, wherein the gateway comprises means for detecting whether a function violating a security policy is included in the web content that has been converted into a format executable in the web browser of the terminal.

10. The system of claim 9, wherein, if a file having a function violating the security policy is included in the web content, the gateway comprises means for preventing transmitting the file to the terminal.

11. The system of claim 9, wherein, if a file having a function violating the security policy is included in the web content, the gateway comprises means for obtaining approval from a terminal user before transmitting the file to the terminal.

12. The system of claim 9, wherein, if a file having a function violating the security policy is included in the web content, the gateway comprises means for inserting code into the file, wherein the code causes a predetermined action to be performed at runtime, and the predetermined action is determined by a predetermined security policy of the system.

13. A system for providing executable web content to a terminal, wherein the system comprises:
a server, which provides executable web content, and
a gateway, which receives the executable web content from the server, converts it into a format executable in a web browser of the terminal, and transmits the converted content to the terminal,
wherein the web content comprises at least one of a static file, a dynamically generated file, a source code of procedural code, an executable binary file and a multimedia file, and
the gateway can compile both declarative language and procedural code.

14. The system of claim 6 or 13, wherein the source code of the procedural code comprises Java code, and the executable binary file comprises jar file.

15. A gateway that receives an executable web content from a server and converts it into a format executable in a web browser of a terminal, wherein the web content comprises at least one of a static file, a dynamically generated file, a source code of procedural code, an executable binary file and a multimedia file, and the gateway comprises a complier for compiling declarative language and procedural code and converting into an executable file.

16. The gateway of claim 15, wherein the terminal is a wireless communication terminal, and the web content is wireless web content.

17. The gateway of claim 15, wherein the gateway communicates with the web server via wired network, and the gateway communicates with the terminal via wireless network.

18. The gateway of claim 17, wherein
the terminal comprises a wireless web browser,
the gateway receives a request for the web content from the wireless web browser via wireless network, and requests the web content to the server via wired network,
the web content comprises one more files,
the request for the web content to the server comprises a request for at least a part of the one or more files, and
the gateway transmits the one or more files included in the web content to the terminal in one transaction.

19. The gateway of claim 18, wherein
the one or more files included in the web content comprises a web content file and resource files, and
the request for the web content comprises a request for web content file and a request for resource files.

20. The gateway of claim 15, wherein the source code of the procedural code comprises Java code, and the executable binary file comprises jar file.

21. The gateway of claim 15, comprising:
a converter for converting declarative language part into procedural code;
a complier for compiling the procedural code;
a handler for analyzing the executable binary file received from the web server and, if an external file is referenced, fetching the external file; and
a security manager for determining whether a function causing a security problem is included in the web content received from the web server.

22. The gateway of claim 15, comprising means for detecting whether a function violating a security policy is included in the web content that has been converted into a format executable in the web browser of the terminal.

23. The gateway of claim 22, wherein, if a file having a function violating the security policy is included in the web content, the gateway does not transmit the file to the terminal.

24. The gateway of claim 22, wherein, if a file having a function violating the security policy is included in the web content, the gateway receives approval from a terminal user before transmitting the file to the terminal.

25. The gateway of claim 22, wherein, if a file having a function violating the security policy is included in the web content, the gateway inserts code into the file, wherein the code causes certain action to be performed at runtime, and the certain action is determined by a predetermined security policy of the system.

26. The gateway of claim 17, wherein,
the terminal comprises a wireless web browser,
a web content comprises at least one file,
the gateway receives a request for a web content from the wireless web browser via wireless network,
the request for the web content comprises a name and a last modified time information of the file that is already cached in the browser,
the gateway requests the web content to the server via wired network, the request for the web content to the server comprises a request for the at least one file, and
the gateway receives at least one file included in the web content, which is received from the server in response to the request to the server, compares with the name and last modified time information of the cached file, and transmits only the file which has been modified from the cached file or has been newly added to the terminal.

27. A computer storage media for storing a web browser for browsing an executable web content, wherein the web browser receives and executes web content in binary executable code format.

28. A terminal comprising a web browser for browsing an executable web content, wherein the web browser receives and executes web content in binary executable code format.

29. The terminal of claim 28, wherein
the web content comprises at least one file, and the at least one file comprises a shared resource file which is referenced by web content, and
the terminal comprises a cache, and
when the shared resource file is cached in the cache, a reference count representing how many files reference the shared resource file are saved together.

30. The terminal of claim 29, wherein, if the terminal receives web content comprising a file of a version newer than a cached version of the cached shared resource file, the shared resource file of the newer version is saved in the cache, and the reference count of the existing cached shared resource file is decreased by 1.

31. The terminal of claim 30, wherein, if the reference count after the decrease is 0, the existing cached shared resource file is deleted.
